(19) United States
(12) Patent Application Publication
(10) Pub. No.: US 2006/0073234 A1
(43) Pub. Date: Apr. 6, 2006

(54) Concrete stamp and method of manufacture

(76) Inventor: Michael E. Williams, Canyon Lake, CA (US)

Correspondence Address: MICHAEL BEST & FRIEDRICH, LLP, 100 E WISCONSIN AVENUE, MILWAUKEE, WI, 53202, US

(21) Appl. No.: 10/959,382

(22) Filed: Oct. 6, 2004

(51) Int. Cl. B29C 33/40

(52) U.S. Cl. 425/542; 264/225; 264/227

(57) ABSTRACT

A method of forming a concrete stamp. The method includes forming a positive mold representative of a natural surface and providing a mold base having a first portion and a second portion. The method further includes attaching the positive mold to the first portion and positioning the second portion in contact with the first portion to at least partially define a cavity. The method also includes injecting a material into the cavity.

### BACKGROUND

The present invention relates to a concrete stamp suited to forming patterns in concrete. More particularly, the present invention relates to a method of manufacturing a concrete stamp suited to forming patterns in concrete.

Concrete stamps have become very popular in recent years. The stamps are used to produce the appearance of a natural surface (e.g., slate, flagstone, brick, cobblestone, wood, and the like) in a poured concrete surface. The stamps are pressed into the concrete as the concrete sets to create the appearance of the natural surface. Coloring agents can be applied to further enhance the illusion of a natural surface.

Prior concrete stamps were manufactured by creating a mold around the natural surface to be copied, and filling that mold with a setting material, such as thermosetting plastic. After several hours, the material sets and is removed from the natural surface. This process is very slow and costly. In addition, it is difficult to quickly and inexpensively create multiple stamps that include varying patterns.

### SUMMARY

The present invention provides a method of forming a concrete stamp. The method includes forming a positive mold representative of a natural surface and providing a mold base having a first portion and a second portion. The method further includes attaching the positive mold to the first portion and positioning the second portion in contact with the first portion to at least partially define a cavity. The method also includes injecting a material into the cavity.

The invention also provides a method of forming a concrete stamp. The method includes forming a negative mold representative of a natural surface, forming a positive pattern using the negative mold, and forming a casting mold using the positive pattern. The method also includes casting a mold insert using the casting mold, the mold insert including a metal portion, and attaching the mold insert to a first mold portion. The method further includes positioning a second mold portion in contact with the first mold portion to define a cavity and injecting a plastic material into the cavity at high pressure.

The invention also provides a mold suitable for use in injection-molding a concrete stamp. The mold includes a first mold portion, a second mold portion, and an insert that includes a cast portion having a surface that is a substantial copy of at least a portion of a natural surface. The insert is coupled to the second mold portion. The first mold portion, the second mold portion, and the insert cooperate to define at least a portion of a cavity corresponding to the concrete stamp.

The invention further provides a method of forming a concrete stamp. The method includes forming a negative mold representative of a natural surface and forming a positive pattern using the negative mold by positioning a thermosetting material in intimate contact with a surface to be copied such that the negative mold is a substantial copy of the surface to be copied. The method also includes forming a sand casting mold using the positive pattern, casting a first metal mold insert using the casting mold, and forming a second metal mold insert representative of a second natural surface different from the first natural surface. The method further includes attaching one of the first metal mold insert and the second metal mold insert to a first mold portion and forming a third mold insert corresponding to the one of the first metal mold insert and the second metal mold insert attached to the first mold portion. The method also includes attaching the third mold insert to a second mold portion, positioning the second mold portion in contact with the first mold portion to define a cavity, and injecting a plastic material into the cavity at high pressure using an injection-molding process.

### BRIEF DESCRIPTION OF THE DRAWINGS

The description particularly refers to the accompanying figures in which:

FIG. 1 is a perspective view of a natural surface to be copied;

FIG. 2 is a perspective view of a first mold;

FIG. 3 is a perspective view of a first positive pattern;

FIG. 4 is a schematic illustration of a casting mold;

FIG. 5 is a perspective view of an injection-molding mold including a mold insert;

FIG. 6 is a perspective view of a concrete stamp in use;

FIG. 7 is a flowchart illustrating one manufacturing process suitable for use in manufacturing a concrete stamp; and

FIG. 8 illustrates another concrete stamp having a second surface texture.

Before any embodiments of the invention are explained, it is to be understood that the invention is not limited in its application to the details of construction and the arrangements of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof is meant to encompass the items listed thereafter and equivalence thereof as well as additional items. The terms “connected,” “coupled,” and “mounted” and variations thereof are used broadly and encompass direct and indirect connections couplings, and mountings. In addition, the terms “connected” and “coupled” and variations thereof are not restricted to physical or mechanical connections or couplings.

### DETAILED DESCRIPTION

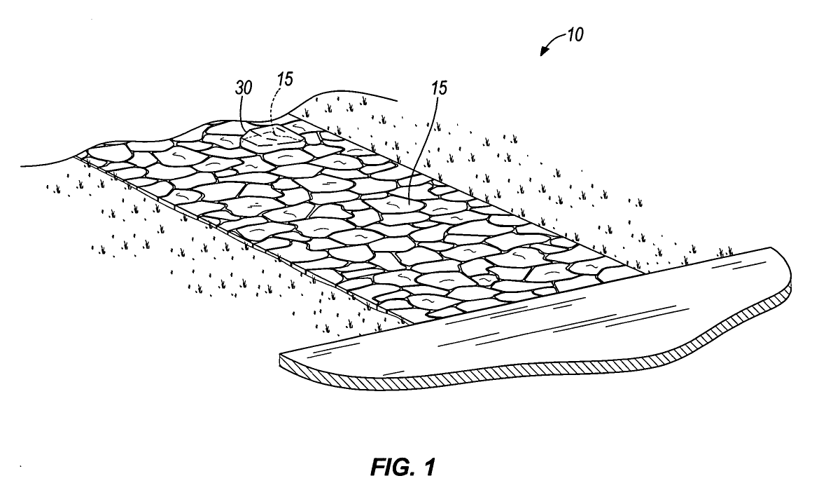

With reference to FIG. 1, a walkway 10 formed from an arrangement of natural stones 15 is illustrated. FIG. 1 illustrates one pattern and type of stone 15 that can be used for such a walkway 10 with many other patterns and textures being possible. A walkway 10 of this type can be expensive and time consuming to build, as the stones 15 must be individually placed and fit, usually by a skilled artisan.

A walkway 12 (shown in FIG. 6) that appears nearly identical to the walkway 10 of FIG. 1 can be produced quickly and inexpensively using a concrete stamp 20 as illustrated in FIG. 6 and formed as described herein. The stamp 20, illustrated in FIG. 6, matches the shape of one of the stones 15 in the walkway 10 of FIG. 1. Additional stamps 20 could be produced to match other stones 15, or multiple stones 15 could be copied in one stamp 20 to allow for the creation of many different patterns. For example, one construction uses a stamp 25 that copies cobblestone, as shown in FIG. 8. In this construction, a large stamp 25 that includes multiple cobblestone copies is employed. As one of ordinary skill will realize, many different size patterns could be employed. The size of the stamp being employed depends on many factors including the pattern being copied.

The stamps 20 are manufactured such that they include at least one surface that is a substantial copy of an existing natural surface (e.g., slate, flagstone, cobblestone, brick, pave stones, granite, sandstone, wood, and the like). Thus, the surface of the stamp 20 appears to include wood grain, cracks, crevices, indentations, bumps, chips, and/or any other variations commonly found on natural surfaces. Generally, these features are somewhat random and are too complex to accurately model with a computer, or to machine with present machine tools. As such, the surfaces generally must be copied directly to be reproduced.

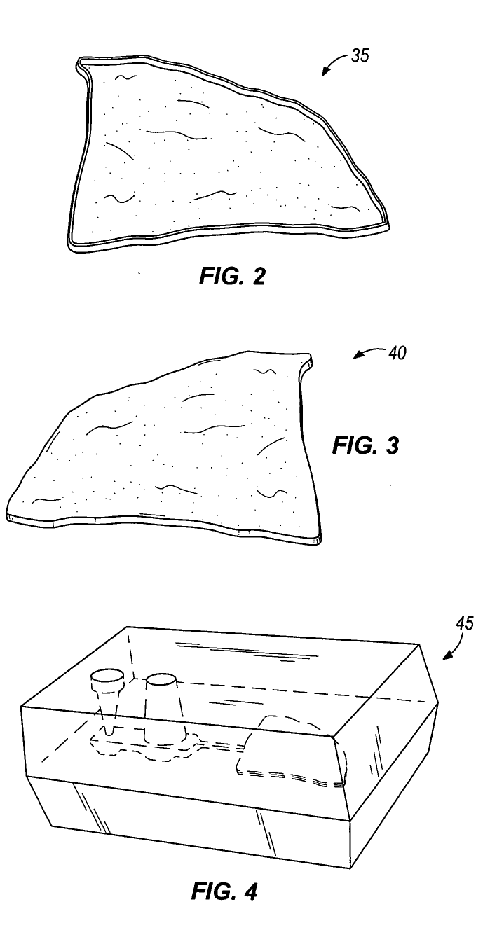

To manufacture the concrete stamp 20 illustrated in FIG. 6, a mold 30 is first positioned around the natural surface to be copied. In this case a single stone 15 is being copied. However, in other constructions a square, rectangular or other shaped area may be copied. Once the mold 30 is positioned, a liquid material is pored into the mold 30. The liquid material is of a viscosity and consistency that allows the liquid to flow into the many cracks, crevices, indentations, and other surface features of the stone 15. Generally, a thermosetting plastic, such as polyurethane, is used as the liquid. Once the material sets, it defines a negative mold 35 that can be removed from the mold 30. The negative mold 35, illustrated in FIG. 2, is representative of the natural surface, in that low spots in the natural surface appear as high-spots in the mold 35. In addition, the surface features and the surface texture is captured by the negative mold 35.

The negative mold 35 is used to make a positive pattern 40, or copy of the original stone 15, as shown in FIG. 3. Many materials can be used to form the positive pattern 40. For example, thermosetting plastic could be poured into the mold 35 to produce the copy.

In some constructions, the formation of the negative mold 35 and the pattern 40 can be omitted and the actual stone 15 itself is used as the positive pattern. Of course, this construction is limited to single stones 15 or simple patterns of stones.

The pattern 40 is used to form a casting mold 45, such as the sand-casting mold illustrated in FIG. 4. The pattern 40 is positioned within the sand-casting mold 45 and sand is distributed around the pattern 40. The sand is such that it makes intimate contact with the surface features of the pattern 40, thereby allowing for a fairly accurate reproduction of most of the surface features. Once the sand is positioned as desired in the two halves of the mold 45, molten metal (e.g., aluminum, iron, steel, and the like) is poured into the mold 45 to form a mold insert 50. In other constructions, other casting methods, such as investment casting, are employed.

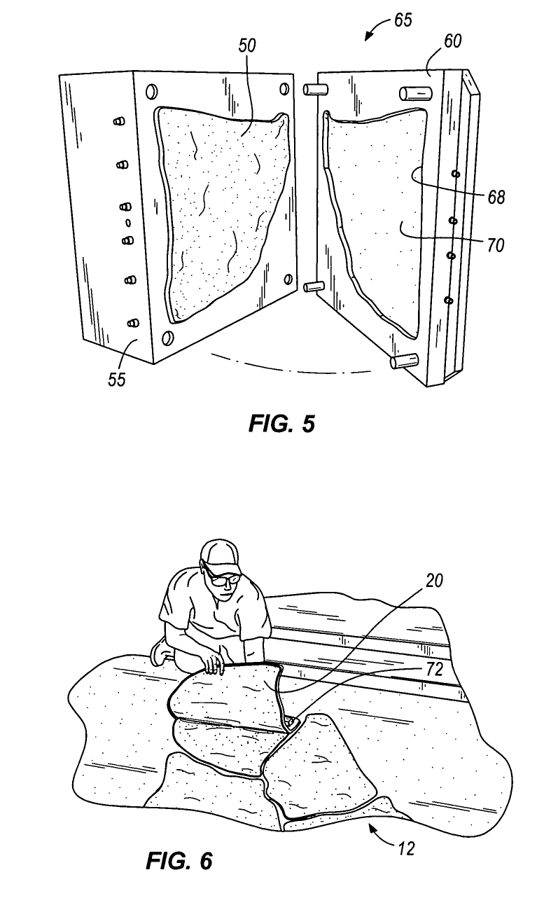

The mold insert 50 is removed from the mold 45 and machined if necessary to allow for its attachment to a first injection mold portion 55, as illustrated in FIG. 5. In preferred constructions, a standard attachment portion is formed as part of, or is attached to, the second pattern 50. The standard attachment portion allows the mold insert 50 to be inserted into the injection mold portion 55. For example, a number of fasteners arranged in a predefined pattern could be employed to attach the mold insert 50 to the mold portion 55. The use of a standard attachment portion allows for additional mold inserts to be manufactured and used with a common mold portion 55.

A second injection mold portion 60 is machined or otherwise formed to receive the mold insert 50 when the first mold portion 55 and the second mold portion 60 are closed. Thus, the first mold portion 55 and the second mold portion 60 cooperate to define an injection mold 65. For complex patterns, such as the one illustrated in FIG. 5, a second cast insert 68 may be required. The second cast insert follows the outer contour of the insert 50, but is offset such that the insert 50 acts as a core, while the second cast insert 68 defines the outer most surface of a cavity 70. The second cast insert 68 is made in much the same manner as the mold insert 50. In addition, the second cast insert 68 is installed into the second mold portion 60 in much the same manner as the mold portion 55.

In the closed position, the two mold portions 55, 60, the pattern 50, and the second cast insert 68 cooperate to substantially define the cavity 70 that corresponds to the finished concrete stamp 20. As such, additional features, such as handles 72, may be defined in one or both of the mold portions 55, 60 such that the completed concrete stamp 20 includes these features.

With the mold portions 55, 60 positioned in the closed position, plastic, in a substantially liquid state is injected into the mold 65 under high-pressure. The plastic fills the cavity 70 and begins to cool and solidify. Once solidified, the mold 65 is opened, the plastic concrete stamp 20 is removed, and the injection molding process is repeated. Thus, the injection molding process allows for the mass production of concrete stamps 20 that have substantially identical surface patterns.

To manufacture concrete stamps 20 having a different surface pattern, the mold 65 is opened and the mold insert 50 is removed. A second mold insert (not shown) having a surface texture corresponding to the different surface pattern desired is installed in the mold 65. The mold portions 55, 60 are then closed and the injection molding process continues. Thus, the process described is able to quickly transition from manufacturing a concrete stamp 20 having a first surface texture, to a concrete stamp having a second surface texture, such as the concrete stamp 25 shown in FIG. 8, with little loss in manufacturing time.

FIG. 6 illustrates one of the concrete stamps in use to form the walkway 12. The walkway 12 is similar to the walkway 10, which is illustrated in FIG. 1. As shown, concrete is first poured and leveled. The stamps 20 are then positioned as desired on the concrete, depressed, and removed to leave a positive copy of the original stone 15.

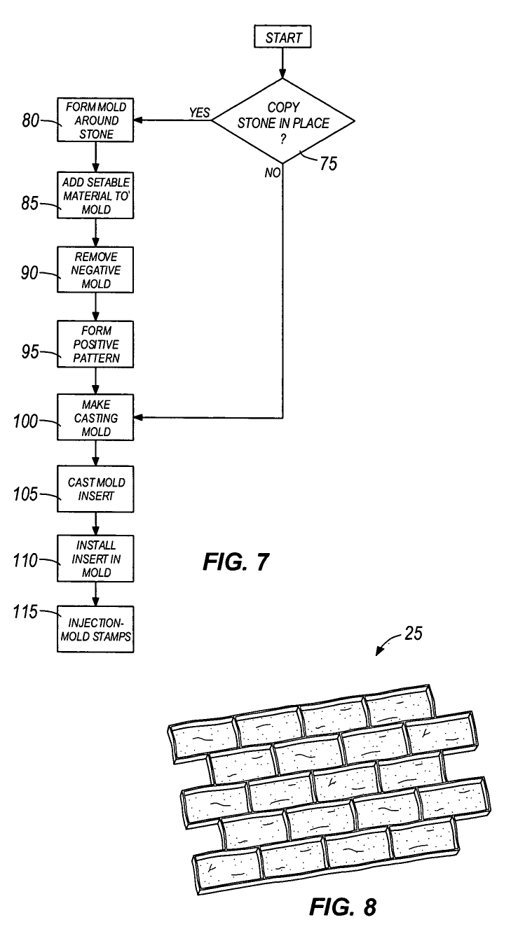

FIG. 7 is a flowchart that illustrates the steps involved in making the concrete stamp 20. The first step 75 is to determine if the actual surface being copied can be used as a pattern, or if it must first be copied. If it must be copied, the surface is framed and the negative mold 35 is made as shown at steps 80, 85, and 90. In the next step 95, the positive pattern 40 is made using the negative mold 35. The positive pattern 40, or the actual stone, is then used to form the casting mold 45 at step 100. The next step 105 is to cast the mold insert 50. The mold insert 50 is then inserted into the mold 65, as shown at step 110, to allow injection molding to begin at step 115.

Although the invention has been described in detail with reference to certain preferred embodiments, variations and modifications exist within the scope and spirit of the invention as described and defined in the following claims.

What is claimed is:

1. A method of forming a concrete stamp, the method comprising:
forming a positive mold representative of a natural surface;
providing a mold base having a first portion and a second portion;
attaching the positive mold to the first portion;
positioning the second portion in contact with the first portion to at least partially define a cavity; and
injecting a material into the cavity.

2. The method of claim 1, further comprising forming a first negative mold from a thermosetting plastic material, the first negative mold being a substantial copy of an actual surface to be copied.

3. The method of claim 2, further comprising forming a pattern using the first negative mold.

4. The method of claim 3, further comprising using the pattern to produce a second negative mold.

5. The method of claim 4, wherein the second negative mold is a sand mold suitable for use in sand casting.

6. The method of claim 5, further comprising forming the positive mold using a metal.

7. The method of claim 1, further comprising forming a second positive mold representative of a second natural surface different from the first natural surface, the second positive mold being interchangeable with the positive mold.

8. The method of claim 1, wherein the injecting step includes injecting a plastic material using an injection-molding process.

9. The method of claim 1, wherein the cavity includes a space corresponding to a handle member.

10. The method of claim 1, further comprising attaching a cast portion to the second portion, the positive mold and the cast portion cooperating to substantially define the cavity.

11. A method of forming a concrete stamp, the method comprising:
forming a negative mold representative of a natural surface;
forming a positive pattern using the negative mold;
forming a casting mold using the positive pattern;
casting a mold insert using the casting mold, the mold insert including a metal portion;
attaching the mold insert to a first mold portion;
positioning a second mold portion in contact with the first mold portion to define a cavity;
injecting a plastic material into the cavity at high pressure.

12. The method of claim 11, wherein the forming a negative mold step includes positioning a thermosetting material in intimate contact with a surface to be copied such that the negative mold is a substantial copy of the surface to be copied.

13. The method of claim 11, wherein the casting mold is a sand mold suitable for use in sand casting.

14. The method of claim 11, further comprising forming the mold insert using a metal.

15. The method of claim 14, wherein the metal is aluminum.

16. The method of claim 11, further comprising forming a second mold insert representative of a second natural surface different from the first natural surface, the second mold insert being interchangeable with the mold insert.

17. The method of claim 11, wherein the injecting step includes using an injection-molding process.

18. The method of claim 11, wherein the cavity includes a space corresponding to a handle member.

19. The method of claim 11, further comprising attaching a cast portion to the second mold portion, the positive mold and the cast portion cooperating to substantially define the cavity.

20. A mold suitable for use in injection-molding a concrete stamp, the mold comprising:
a first mold portion;
a second mold portion; and
an insert that includes a cast portion having a surface that is a substantial copy of at least a portion of a natural surface, the insert coupled to the second mold portion,
wherein the first mold portion, the second mold portion, and the insert cooperate to define at least a portion of a cavity corresponding to the concrete stamp.

21. The mold of claim 20, wherein the insert is one of a plurality of inserts, each of the plurality of inserts including cast metal.

22. The mold of claim 21, wherein the plurality of inserts include at least two surfaces that are substantial copies of two different natural surfaces.

23. A method of forming a concrete stamp, the method comprising:
forming a negative mold representative of a natural surface;
forming a positive pattern using the negative mold by positioning a thermosetting material in intimate contact with a surface to be copied such that the negative mold is a substantial copy of the surface to be copied;
forming a sand casting mold using the positive pattern;
casting a first metal mold insert using the casting mold;
forming a second metal mold insert representative of a second natural surface different from the first natural surface;
attaching one of the first metal mold insert and the second metal mold insert to a first mold portion;
forming a third mold insert corresponding to the one of the first metal mold insert and the second metal mold insert attached to the first mold portion;
attaching the third mold insert to a second mold portion;
positioning the second mold portion in contact with the first mold portion to define a cavity; and
injecting a plastic material into the cavity at high pressure using an injection-molding process.
